(19) United States
(12) Patent Application Publication
(10) Pub. No.: US 2026/0309419 A1
(43) Pub. Date: Oct. 8, 2026

(54) CLIMATE-FRIENDLY PUZZOLANA PRODUCTION

(71) Applicants: thyssenkrupp Polysius GmbH, Beckum (DE); thyssenkrupp AG, Essen (DE)

(72) Inventors: Guido GRUND, Werl (DE); Eugen WAGNER, Werl (DE); Dirk SCHEFER, Ennigerloh (DE)

(73) Assignees: thyssenkrupp Polysius GmbH, Beckum (DE); thyssenkrupp AG, Essen (DE)

(21) Appl. No.: 19/490,245

(22) PCT Filed: Jun. 4, 2024
(86) PCT No.: PCT/EP2024/065279

§ 371 Date: Dec. 4, 2025

(30) Foreign Application Priority Data
Jun. 6, 2023 (DE) 10 2023 114 757.9
Jun. 6, 2023 (LU) LU103142

(51) Int. Cl. F27B 7/20; C04B 14/10; C04B 111/00

(52) U.S. Cl. CPC F27B 7/20; C04B 14/10; C04B 2111/00017

(57) ABSTRACT

A device for producing a thermally activated clay comprises a rotary kiln and a hot gas generating device separated from the rotary kiln, wherein the hot gas generating device and the rotary kiln are connected via a gas line to transfer hot gases generated in the hot gas generating device.

The invention relates to a device and a method for producing a thermally activated clay, an artificial puzzolana, in a rotary kiln.

Since mineral-bound carbon dioxide is released from the limestone itself during the firing process of limestone, activated clays, also known as artificial puzzolana, are increasingly used to reduce carbon dioxide emissions in the cement sector, since when activated, such carbon dioxide is not released from the clay. Thus, when activating clays, the energy source and thus the fuel used is the substantial source of carbon dioxide emissions. In order to reduce these emissions, alternative fuels are increasingly being used, but they are more demanding in terms of combustion.

Originally, the artificial puzzolana were produced by the thermal activation of clays in a rotary kiln. However, since the use of alternative fuels is not unproblematic in a rotary kiln, entrained-flow processes are currently used, wherein the use of alternative fuels is much easier. Two aspects are important when using alternative fuels. On the one hand, a safe and complete combustion has to be guaranteed. This requires sufficiently high temperatures and sufficiently long combustion times with sufficiently high oxygen supply. In a rotary kiln, however, simultaneous optimization of the activation of the clay and the burning of the alternative fuel is not possible.

A method for producing puzzolana with color change is known from WO 2018/195 642A 2.

Energy recovery in the cooling of color-optimized clays is known from WO 2022/058 206A 1.

A system for producing cement clinker is known from DE 10 2004 009 689A 1.

A device and a method for processing alternative fuels is known from DE 10 2012 108 295A 1.

A method for producing clinker and a second calcined material is known from US 2023/002 277 A1.

A method and a device for producing cement is known from US 2023/110 304A 1.

A method for the treatment of kaolin by recycling urban construction waste is known from CN 113 387 367 A.

A clinker substitute based on a calcined clay is known from US 2014/000 491A 1.

It would be desirable to enable the activation of a clay even in a rotary kiln, while avoiding emissions, in particular by using alternative fuels, such as biomass, as fully as possible.

The object of the invention is to provide a device having a rotary kiln for the thermal activation of clays, which manages without firing of primary raw materials such as oil or gas in the rotary kiln and can thus be operated in a particularly climate-friendly manner.

This object is achieved by the device having the features specified in claim 1 and by the method having the features specified in claim 13. Advantageous refinements will be apparent from the subclaims, the description that follows, and the drawings.

The device according to the invention is used to produce a thermally activated clay. The device comprises a rotary kiln and a hot gas generating device separate from the rotary kiln. The separation allows a separation of the process conditions, so that, for example, alternative fuel can be employed in the hot gas generating device under optimal conditions for the combustion of the alternative fuel, while the process conditions in the rotary kiln can be optimized for the activation of the clay. The hot gas generating device and the rotary kiln are connected via a gas line for transfer of hot gases generated in the hot gas generating device. Since only the hot gas is thus transferred through the gas line, the advantage of separating the two thermal processes results, on the one hand. On the other hand, it is disadvantageous that the energy generation is no longer directly carried out in the rotary kiln and that the heat transfer from the gas to the clay is therefore limited. This makes thermal activation difficult without direct heat generation in a rotary kiln. The hot gas generating device is a combustion device for an alternative fuel or an electric gas heater. It is therefore a discrete hot gas generating device, the function of which is the generation of hot gas, and not a process in which a hot gas arises as a waste product. The use of a combustion device for an alternative fuel and/or an electric gas heater allows the CO₂-free generation of the thermal energy, for example, when biomass is used as an alternative fuel or electricity from a regenerative source is used for the electric gas heater. An alternative fuel can, of course, be a mixture within the meaning of the invention. Alternative fuels are waste or biomass, for example, or also a mixture of these, for example.

In another embodiment of the invention, the device comprises a first temperature sensor. The first temperature sensor is an infrared sensor. The first temperature sensor is arranged in the outlet area below the rotary kiln. This special arrangement allows contactless (wear-free) measurement of the temperature of the activated clay. With the usual measurement from above, such a reliable temperature measurement is not possible, because dust influences the measurement. A measurement of the emerging material from the lower side, on the other hand, has proved to be very reliable.

In another embodiment of the invention, the device comprises a second temperature sensor.

The second temperature sensor is arranged in or on the rotary kiln. For example, the second temperature sensor can be arranged on the outer side of the rotary kiln. Here, of course, only the outside temperature of the rotary kiln is measured. The advantage is that this is low-maintenance and wear-free. The disadvantage is that the measurement is comparatively inaccurate. Alternatively, the second temperature sensor can be arranged in a fire-resistant protective tube in the interior of the rotary kiln. This makes it possible to measure the material in the rotary kiln. For example, the second temperature sensor can be surrounded and protected by a metallic safeguard on three sides.

In another embodiment of the invention, the gas line has a length, so that the gas has a dwell time within the gas line between 0 and 10 s, preferably between 0.5 and 10 s. Thus, for example, the gas pipe can be embodied as shorter, but having a larger inner diameter, or longer, and with a smaller inner diameter. The gas line preferably has a length such that the gas has a dwell time within the gas line between 1 and 5 s. More preferably, the gas line has a length such that the gas has a dwell time within the gas line between 1.5 and 2.5 s. This dwell time in the gas line can ensure a safe burnout if this has not already taken place in the hot gas generating device. This makes it possible to use a hot gas generating device, which itself does not, for example, comply as such with the legal requirements for safe burnout. In addition, other measures, such as the supply of ammonia or urea, can be used to remove possible nitrogen oxides. Appropriate reaction times are also useful for this purpose.

In another embodiment of the invention, the device comprises a material cooler. The rotary kiln is connected to the material cooler to transfer the thermally treated clay. The material cooler is connected to the hot gas generating device for transferring gas preheated in the material cooler. In this way, the finished product is cooled, on the one hand, and the heat is returned to the process, on the other hand. Preferably, a dust filter is arranged between the material cooler and the hot gas generating device. The dust collected in this case is preferably fed into the finished product.

In another embodiment of the invention, the material cooler is a drum cooler. Preferably, the gas flow in the drum cooler is guided in counter-flow to the material flow. The advantage of the drum cooler is that the particle size of the activated clay is less relevant in comparison to fluidized heat exchangers. Therefore, the requirements for the clay and the energy required for the pulverization are correspondingly low.

In another alternative embodiment of the invention, the material cooler is a walking floor, two-layer cooler, or grate cooler.

In another alternative embodiment of the invention, the material cooler is a cyclone cooler or fluidized bed cooler. The advantage is that much faster cooling can be achieved here. It is disadvantageous, however, that the maximum particle size of the activated clay is limited to a particle size that is able to fly (for example, less than 2 mm).

In another embodiment of the invention, a crusher device is arranged between the rotary kiln and the material cooler. For example, the crusher device is a roller crusher. The crusher device can in particular be cooled, preferably air-cooled. This is particularly preferred if the material cooler is a cyclone cooler or fluidized bed cooler.

In another embodiment of the invention, a screen, in particular a drum screen, is arranged between the rotary kiln and the material cooler. Particularly preferably, a crusher is arranged behind the coarse outlet of the screen, in particular the drum screen. This can significantly reduce the amount of hot material to be crushed applied to the crusher, making heat less problematic.

The screen can also be designed as a static screen, in particular as a screen having an inclination of 30°to 60°. As a result, a purely gravity-driven transport is possible and therefore active conveying can be dispensed with.

Preferably, the screen has a mesh size of 2 mm, so that particles less than 2 mm in size can pass and particles more than 2 mm in size are retained.

In another embodiment of the invention, the device comprises a product recirculation function. The product recirculation function is designed to recirculate product cooled in the material cooler between the rotary kiln and the material cooler. This is particularly preferred when a crusher device is arranged between the rotary kiln and the material cooler, since in this way, by mixing hot activated clay coming from the rotary kiln with cold recirculated activated clay, rapid cooling and thus a lower thermal load for the crusher device can be achieved. For further embodiments, reference is made to DE 10 2020 211 750A 1.

In another embodiment of the invention, the device comprises a pre-cooler. The pre-cooler is arranged between the rotary kiln and the material cooler. The pre-cooler has direct or indirect water cooling. In direct water cooling, water is applied directly to the activated clay, in particular sprayed on. This enables extremely fast and efficient cooling, which is particularly advantageous in order to avoid a color change of the activated clay after the thermal treatment, in which the activated clay comes into contact with oxygen at high temperatures. In indirect water cooling, the water is sprayed on the outer side of the pre-cooler and thus the pre-cooler itself is strongly cooled. The disadvantage of the method is the low efficiency in recovering heat.

In another embodiment of the invention, the rotary kiln comprises fittings for vertically conveying the clay. The fittings for vertically conveying the clay are used to raise the clay, due to which it then falls through the gas flow in the interior of the rotary kiln, by which the heat transfer from the gas flow to the clay is optimized. The fittings can be straight, angled, or curved fittings. They can be honeycomb or cross fittings or they can be chain elements. It is essential that the clay is at least partially raised by the fittings and thus at least partially falls down again through the gas flow. Since the wear of the fittings is strongly temperature-dependent, these fittings are preferably only installed in the side of the rotary kiln facing away from the hot gas generating device, i.e. in areas of the rotary kiln in which the temperature of the clay is less than 650 °C, optionally less than 500 °C.

In another embodiment of the invention, the rotary kiln comprises baffle rings. This increases the fill level in the rotary kiln, increases the dwell time, and thus improves the heat transfer from the gas phase to the clay to be activated. Preferably, the rotary kiln comprises one or more baffle rings.

In another embodiment of the invention, the gas line has a nitrogen supply for removing nitrogen oxides. For example, ammonia, aqueous ammonia solution, urea solution, or the like can be supplied via the nitrogen supply, so that the supplied nitrogen is comproportioned with nitrogen oxides and thus the nitrogen oxides are removed. Further possible embodiments can be found in DE 10 2022 209 826 in particular.

In another embodiment of the invention, a suction-draft fan is arranged behind the rotary kiln in the gas flow direction. Due to the high temperatures in the gas line between the hot gas generating device and the rotary kiln, a fan is not arrangeable there, so that the conveying power is preferably completely from the suction-draft fan. This in turn results in the pressure in the hot gas generating device being higher than the pressure in the rotary kiln. Due to the negative pressure in the rotary kiln, which is typically only very low, this has the result that the hot gas generating device has practically no negative pressure, possibly even a small positive pressure. Such an operation is unusual for the combustion of alternative fuels.

In another embodiment of the invention, a dust filter is arranged after the rotary kiln in the gas flow direction. The dust filter is connected to the rotary kiln to return the collected dust. Due to the indirect heating and the associated higher gas flow through the rotary kiln, a higher level of dust generation and thus a discharge of ultrafine material with the gas flow from the rotary kiln is to be expected.

In another embodiment of the invention, the rotary kiln has a larger diameter in the middle area. In particular, the middle area between the first baffle ring and the second baffle ring is widened. The middle temperature range is also to be found in the middle area. The widening reduces the flow speed in this area, which in turn reduces the discharge of ultrafine material and improves the heat exchange between gas and clay in this area.

In another embodiment of the invention, the device comprises a pre-heater and/or a dryer. The pre-heater or dryer is located after the rotary kiln in terms of gas flow and before the rotary kiln in terms of material flow. Although drying and heating can also take place completely and exclusively in the rotary kiln, it is advantageous due to the larger gas flow due to the external generation of the hot gas flow if the heat transfer takes place in an additional dryer and/or pre-heater. The pre-heater can be designed as a cascade of cyclone pre-heaters or as a riser tube heat exchanger having a longer dwell time and a separation cyclone. A drum dryer is preferably used as the dryer. The advantage of the drum dryer is that it can also work with very coarse particles (up to the cm range). Likewise, a mill or a crusher with a subsequent riser tube dryer having a separation cyclone can be used as a dryer.

In another embodiment of the invention, the hot gas generating device is a combustion device for an alternative fuel. The combustion device is particularly preferably designed for the combustion of biomass. Alternatively, it can be an electrically operated superheater, which would also be climate-neutral when operated using regeneratively generated electricity.

In another embodiment of the invention, the combustion device comprises a gas-tight solid discharge. This makes it possible to operate the combustion device even with a positive pressure.

In another embodiment of the invention, the combustion device is a reciprocating grate, a rotary tube, a direct flow grate, or a rotary hearth.

In another embodiment of the invention, the rotary kiln comprises an auxiliary combustion device. When using alternative fuels, such as biomass, there are usually fluctuations in the calorific value and moisture, so that the temperature produced in the combustion device is subject to fluctuations. These can be mitigated in control technology by the supply of the alternative fuel, but this is often slow. Therefore, it can be useful to provide an auxiliary combustion device that works with a fuel which is simple to dose, and burns quickly and easily. Typically, this can be a gas burner to also avoid these carbon dioxide emissions, for example, for biogas. This allows these fluctuations to be reacted to very quickly and the temperature in the rotary kiln thus to be kept particularly constant.

In another embodiment of the invention, the device comprises a mixing device. The mixing device is designed for mixing the clay with a reducing agent. The mixing device is arranged in the direction of the material flow before the rotary kiln. For example, the mixing device can be arranged between a dryer and the rotary kiln. Coal, for example, can be used as a reducing agent. Unburnt carbon residues from the combustion device, for example, can also be used. The mixing creates a locally reducing atmosphere around the clay to be activated in the rotary kiln, which in turn prevents the clay from adopting an unwanted color, for example, due to the oxidation of iron. However, it is essential that only little enough reducing agent is used, so that no interfering reducing agent ends up in the finished product.

In another embodiment of the invention, the rotary kiln comprises at least one laterally arranged supply device for a reducing agent. The laterally arranged supply device can be, for example, a so-called scoop feeder. In this way, the reducing agent can in particular be supplied directly in the correct temperature range.

In another embodiment of the invention, the rotary kiln comprises at least one laterally arranged air supply. In particular, oxygen-containing gas can be supplied through the air supply. This allows complete combustion of, for example, a reducing agent or its gaseous reaction products.

At the same time, an extremely oxygen-poor environment can be maintained, especially in the range of the highest temperature.

In another aspect, the invention relates to a method for operating a device according to the invention. The clay is in this case thermally activated in a rotary kiln by means of hot gas generated outside the rotary kiln. As already mentioned, the spatial separation of hot gas generation and thermal activation is essential, due to which both can be optimized separately from one another. In particular, the hot gas generating device can operate by means of a alternative fuel at sufficiently high temperatures with sufficient oxygen over a sufficiently long time, whereas the thermal activation is carried out in particular at lower temperatures and preferably very low oxygen content. The hot gas is supplied to the rotary kiln at a temperature of 600 to 1800 °C. If alternative fuels are used, a temperature of 800 to 1200 °C is preferred, or 600 to 1800 °C with an electric gas heater. The highest temperatures preferably result if a combustion device for an alternative fuel and an electric gas heater are combined. The temperature range is in some cases very significantly above that for the thermal treatment of clays. However, since the temperature decreases due to energy consumption due to the thermal treatment, the clay does not heat up to the full temperature of the hot gas, at which the clay would be deactivated. Therefore, this temperature window has proven to be sufficient and not too high, good activation takes place without deactivation due to excessively high temperature. This is important because the amount of heat supplied in this way has to be sufficient for activation, since the activation is activated exclusively by the hot gas supplied from the outside, i.e. no additional combustion or other energy supply takes place within the rotary kiln.

In another embodiment of the invention, the pressure in the combustion device is higher than the pressure in the rotary kiln. This mode of operation is preferred in order to be able to work only by means of a suction-draft fan after the rotary kiln with respect to the gas flow. The pressure in the hot gas generating device can be selected to be at or even above the ambient pressure in this case.

In another embodiment of the invention, the temperature in the combustion device is selected to be higher than the temperature in the rotary kiln. This makes it possible to safely combust alternative fuels, such as biomass, without this having a negative effect on product quality, since too high a temperature will result in the deactivation of the clay.

In another embodiment of the invention, the temperature in the rotary kiln is regulated by the supply of alternative fuel to the combustion device. The advantage is that no other, mostly primary, fuels have to be used, and thus carbon dioxide emissions from non-regenerative fuels can be minimized.

In another embodiment of the invention, the clay is supplied to the rotary kiln together with a reducing agent. The reducing agent can, for example, be coal, wood, or other biogenic materials, preferably not completely combusted residues from the combustion of a alternative fuel. Due to the joint introduction, a local reducing atmosphere is created in the area of the clay to be activated in the rotary kiln, which prevents, for example, iron from being oxidized in the clay and thus the clay adopting an undesirable color for the product upon activation. This further assists the separation between the conditions in the hot gas generation and the activation, since the oxygen concentration can thus also be selected more freely.

In another embodiment of the invention, oxygen or an oxygen-containing gas mixture is introduced into the rotary kiln in a temperature range of the process gas of 400 to 850°C, preferably 500 to 650 °C. This is preferably done to ensure the complete combustion of not completely reacted combustion products of the organic components of the feed material (clay) and/or the not fully reacted reaction products of a reducing agent.

In another embodiment of the invention, the oxygen content after the hot gas generating device in the gas line is selected to be less than 2 vol.-%, preferably less than 1 vol.-%. This minimizes the oxidation of a clay and thus an unwanted color change.

In another embodiment of the invention, the hot gas generating device is electrically heated. The use of green electricity thus also makes it possible to avoid carbon dioxide emissions.

In another embodiment of the invention, a thermal energy of 300 to 1200 kcal per kg of product is supplied to the rotary kiln via the hot gas. The amount of heat supplied results from the heat capacity of the hot gas as well as the temperature of the hot gas upon entering the rotary kiln and the temperature upon exiting from the rotary kiln, i.e. the amount of heat actually emitted from the hot gas in the rotary kiln.

In another embodiment of the invention, 1 to 5 standard cubic meters of hot gas are supplied to the rotary kiln per kg of product.

In another embodiment of the invention, the dwell time of the clay in the rotary kiln is selected to be between 15 and 90 minutes. The dwell time is higher than for combustion in the rotary kiln, because the resulting temperature gradient is stronger and, on the other hand, heat transfer from radiant heat as with an open flame is eliminated. Thus, only the direct transfer of heat from the gas to the clay is possible, which is why good mixing can result in shortening of the dwell time. The dwell time in the rotary kiln is adjusted in particular via speed, inclination, and the installation of fittings, in particular baffle rings.

In another embodiment of the invention, the activation is regulated such that the hot gas leaves the rotary kiln at the kiln inlet at 100 to 600 °C.

The device according to the invention is explained in more detail hereinafter on the basis of an exemplary embodiment shown in the drawings.

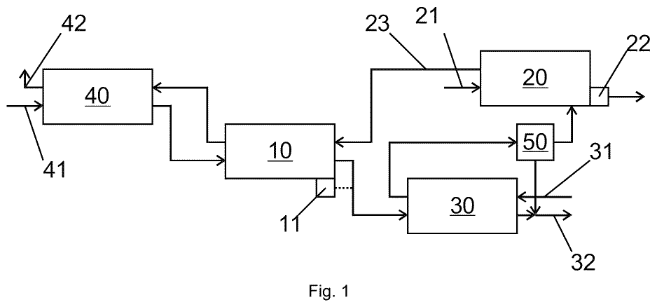

FIG. 1 first example

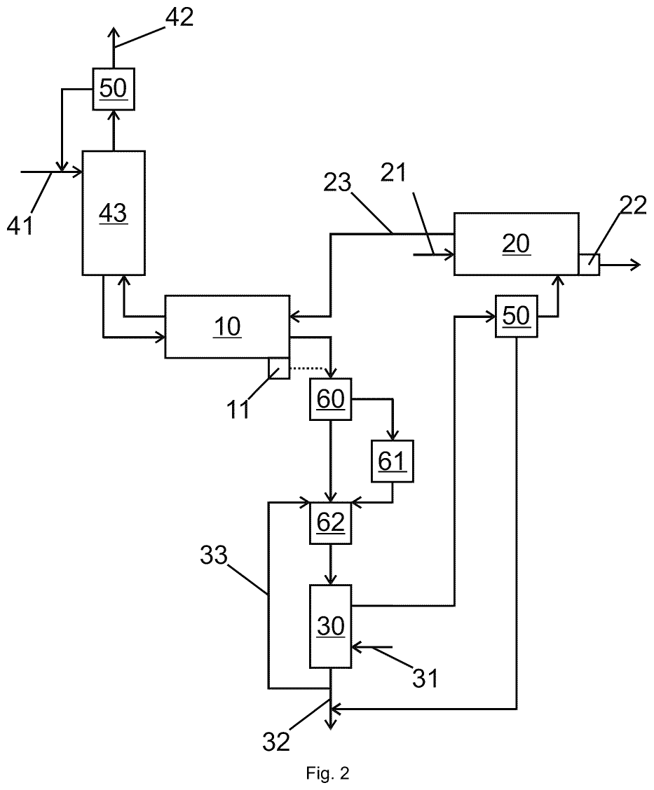

FIG. 2 second example

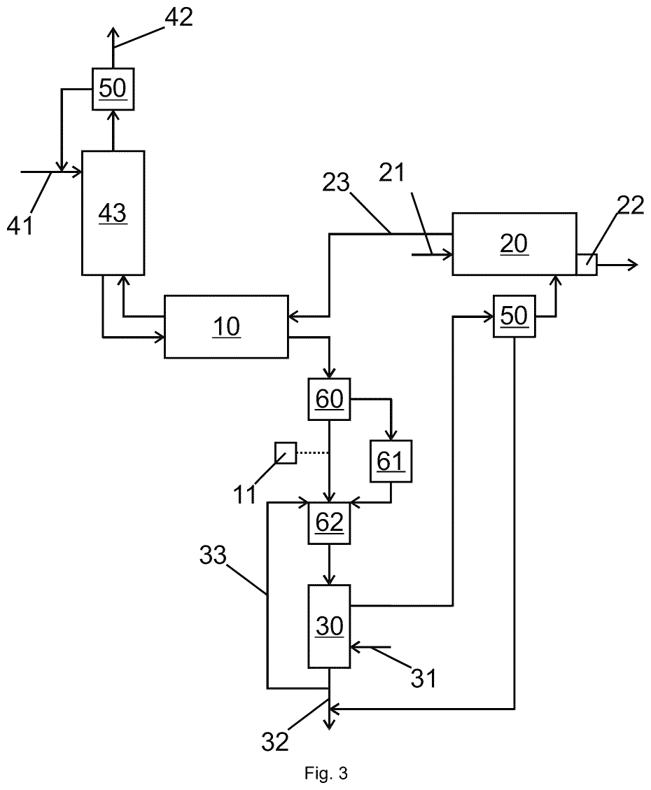

FIG. 3 third example

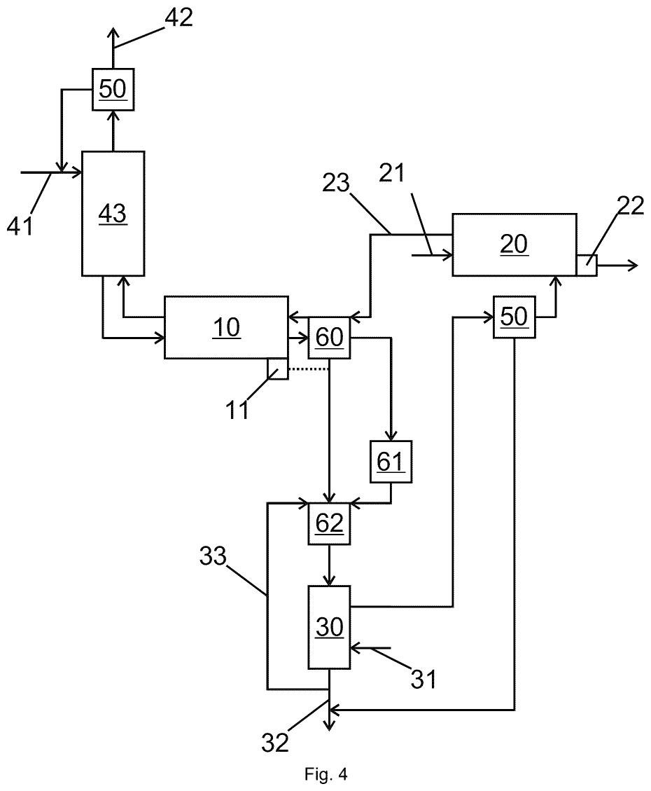

FIG. 4 fourth example

FIG. 1 shows a first example of a device according to the invention. The clay to be activated is fed into a dryer 40, for example, a drum dryer, via a clay supply. From there, the clay is transferred to a rotary kiln 10, where it is thermally treated. The activated clay is transferred from the rotary kiln 10 to a material cooler 30 and cooled there. During the transfer, the temperature of the clay is detected by means of a temperature sensor 11, which is arranged below the rotary kiln 10 and can thus detect the temperature without contact and without wear by means of infrared and without heavy dust load. The cooled activated product is removed from the material cooler 30 via the product outlet 32. This is the material flow through the device. The gas flow runs in counterflow thereto. The cold gas is supplied to the material cooler 30 via the gas supply 31 and heated there. The heated gas is fed into a dust filter 50. The separated dust is supplied to the product at the product outlet 32. The dust-free heated gas is fed to the hot gas generating device 20. An alternative fuel, such as biomass, is introduced into the hot gas generating device 21 via an alternative fuel supply 21 and combusted safely and completely therein, for example, at 1100 °C for at least 20 s. Residues of the alternative fuel are discharged via an airlock 22 so that the hot gas generating device 21 can be operated under a slight positive pressure. The hot gas generated in the hot gas generating device 21 is fed into the rotary kiln 10 via a gas line 23, which has a length so that hot gas remains in the gas line 23 for approximately 5 s. The heat transfer to the clay to be activated and thus the activation of the clay takes place there. Since the heat is not generated within the rotary kiln 10, it can be assumed that a part of the heat is transferred indirectly, i.e. first from the gas to the rotary kiln 10 and then from the rotary kiln 10 to the clay, since the surface of the rotary kiln 10 is larger than the surface of the clay in the rotary kiln 10. The gas which has cooled down significantly in the rotary kiln 10 is supplied from the rotary kiln 10 to the dryer 40. The dryer 40 is embodied as a drum dryer. The gas is then discharged from the dryer 40 via the exhaust gas 42.

FIG. 2 shows a second example of a device according to the invention. The clay is fed via the clay supply 41 into a pre-heater 43, which is designed as a cascaded entrained-flow heat exchanger. The material pre-heated in the pre-heater 43 is transferred to the rotary kiln 10 and thermally activated there. The material activated in the rotary kiln 10 is guided past the temperature sensor 11 onto a screen 60. For example, particles of more than 2 mm in size are fed into a crusher 61, and the fine material of less than 2 mm in size is fed from the screen 60 together with material crushed in the crusher 61 into a mixer 62 and mixed therein with cold, recirculated material and subsequently cooled in a material cooler 30 in the form of an entrained-flow heat exchanger. The activated and cooled material leaving the material cooler 30 is divided and partly returned to the mixer 62 via the product return 33 and partly discharged via the product outlet 32. The gas flow is guided analogously to the first example, except that a dust filter 50 is arranged after the pre-heater 43, to transfer ultrafine material via the pre-heater 43 back into the rotary kiln 10 and thus ultimately into the finished product.

The third example shown in FIG. 3 differs from the example shown in FIG. 2 in that the temperature sensor 11 is arranged below the screen 60.

The fourth example shown in FIG. 4 differs from the second example shown in FIG. 2 in that the screen 60 is designed as a drum screen and is arranged on a plane with the rotary kiln 10. Therefore, the gas line 23 of the hot gas generating device 20 is connected to the screen 60 so that the hot gas is fed through the drum screen to the rotary kiln 60. Therefore, the temperature sensor 11 is arranged behind the screen 60.

### REFERENCE SYMBOLS

10 rotary kiln
11 temperature sensor
20 hot gas generating device
21 alternative fuel supply
22 airlock
23 gas line
30 material cooler
31 gas supply
32 product outlet
33 product recirculation
40 dryer
41 clay supply
42 exhaust gas
43 pre-heater
50 dust filter
60 screen
61 crusher
62 mixer

1-20. (canceled)

21. A device for producing a thermally activated clay, comprising:
a rotary kiln; and
a hot gas generating device separated from the rotary kiln;
wherein the hot gas generating device and the rotary kiln are connected via a gas line for transferring hot gases generated in the hot gas generating device;
wherein the hot gas generating device is a combustion device for an alternative fuel and/or an electric gas heater.

22. The device as claimed in claim 21, further comprising a first temperature sensor, wherein the first temperature sensor is an infrared sensor, wherein the first temperature sensor is arranged in the outlet area below the rotary kiln.

23. The device as claimed in claim 21, further comprising a second temperature sensor, wherein the second temperature sensor is arranged in or on the rotary kiln.

24. The device as claimed in claim 21, wherein the gas line has a length such that the gas has a dwell time within the gas line between 0.5 and 10 s.

25. The device as claimed in claim 21, further comprising a material cooler, wherein the rotary kiln is connected to the material cooler for transferring the thermally treated clay, wherein the material cooler is connected to the hot gas generating device for transferring gas preheated in the material cooler.

26. The device as claimed in claim 25, wherein a dust filter is arranged between the material cooler and the hot gas generating device.

27. The device as claimed in claim 21, wherein the rotary kiln has fittings for vertically conveying the clay.

28. The device as claimed in claim 21, wherein the rotary kiln comprises baffle rings.

29. The device as claimed in claim 21, wherein the rotary kiln has a larger diameter in the middle area.

30. The device as claimed in claim 21, wherein the combustion device comprises a gas-tight solid discharge.

31. The device as claimed in claim 21, wherein the combustion device is a reciprocating grate, a rotary tube, a direct flow grate, or a rotary hearth.

32. The device as claimed in claim 21, wherein the rotary kiln comprises an auxiliary combustion device.

33. A method for operating a device as claimed in claim 21, comprising:
thermally activating the clay in a rotary kiln using hot gas generated outside the rotary kiln, wherein the hot gas is supplied to the rotary kiln at a temperature of 600 to 1800 °C.

34. The method as claimed in claim 33, wherein the pressure in the combustion device is higher than the pressure in the rotary kiln.

35. The method as claimed in claim 33, wherein the temperature in the rotary kiln is regulated by the supply of alternative fuel to the combustion device.

36. The method as claimed in claim 33, wherein oxygen or an oxygen-containing gas mixture is introduced into the rotary kiln in a temperature range from 400 to 850 °C.

37. The method as claimed in claim 33, wherein after the hot gas generating device, the oxygen content is less than 2 vol.-% in the gas line.

38. The method as claimed in claim 33, wherein a thermal energy of 300 to 1200 kcal per kg of product is supplied via the hot gas to the rotary kiln.

39. The method as claimed in claim 33, wherein 1 to 5 standard cubic meters of hot gas are supplied to the rotary kiln per kg of product.

40. The method as claimed in claim 33, wherein the dwell time of the clay in the rotary kiln is between 15 and 90 min.
